(19) United States
(12) Patent Application Publication
(10) Pub. No.: US 2009/0100168 A1
(43) Pub. Date: Apr. 16, 2009

(54) AUTOMATIC LOCATION DETECTION IN A COMPUTING ENVIRONMENT

(76) Inventor: Scott C. Harris, Rancho Santa Fe, CA (US)

Correspondence Address: SCOTT C HARRIS, P O BOX 927649, SAN DIEGO, CA, 92192, US

(21) Appl. No.: 11/277,322

(22) Filed: Mar. 23, 2006

Related U.S. Application Data
(62) Division of application No. 09/578,114, filed on May 24, 2000.

(51) Int. Cl. G06F 15/16

(52) U.S. Cl. 709/224

(57) ABSTRACT

Automatic position location detection, such as satellite position information is used along with a computer to enhance an operation over a remote information channel or a network. This may be used over the Internet to enhance an Internet transaction by determining the origin of the transaction and determining if that origin is authorized. It can also be used for determining a person's location and seeing if the person has moved more than a specified amount in the specified time. It can be used for a biometric scan to determine certain characteristics about the person. Another aspect uses automatic position location to detect handwriting. Yet another application is an automatically determining the source of a request for information from a website, and returning information from that website. This system can also be used in chat room environment.

### PRIORITY UNDER 35 USC § 120

This application is a divisional of U.S. application Ser. No. 09/578,114, filed May 24, 2000, the disclosure of which is herewith incorporated herein by reference.

### BACKGROUND

Computers have been known for carrying out many transactions over a remote communications medium, e.g. a network or a channel. For example, both desktop and portable computers can be used to carry out an operation that requires billing, such as an e-commerce transaction, over the Internet. Hand held telephones such as cellular telephones can be used to place calls and accept billing for those calls. Other portable computing systems such as PDAs and other portable computers also have the capability of carrying out other transactions that may require billing.

These transactions raise various issues including security. The company handling the credit operations can verify the security for certain transactions. For example, in an e-commerce transaction, the transaction is often verified by the credit card company. When the transaction is done in person, additional security is provided by the user's physical possession of the card, and this may itself be enough to verify the transaction. For a transaction over a remote communications medium, no such safeguards are in place.

Computer companies may carry out various attempts to verify the transaction. This can be done, for example, by requiring that the credit card billing address and the shipping address be the same. It has also been suggested to enhance the security of such a transaction using biometrics to uniquely identify an individual.

### SUMMARY

The present application teaches an automatic location detection in combination with a computing system that is used over a remote communications medium.

### BRIEF DESCRIPTION OF THE DRAWINGS

These and other aspects will now be described in detail with reference to accompanying drawings wherein:

FIG. 1 shows a block diagram of a basic hardware layout;

FIG. 2 shows a flowchart of an e-commerce transaction using automatic position detection;

FIG. 3A shows a flowchart of determining allowable positioning of a user;

FIG. 3B shows a positioning circle;

FIG. 4 shows a system of using automatic positioning detection to ascertain biometric characterization;

FIG. 5 shows a system of using automatic positioning detection to detect an aspect of handwriting;

FIG. 6 shows a flowchart of detecting handwriting characteristics;

FIG. 7 shows an operation of determining whether a specified location of a computing operation is an authorized location, using automatic position detecting;

FIG. 8 shows an operation of returning content for a website based on automatic position location; and

FIG. 9 shows a secure identification system using automatic position location.

### DETAILED DESCRIPTION

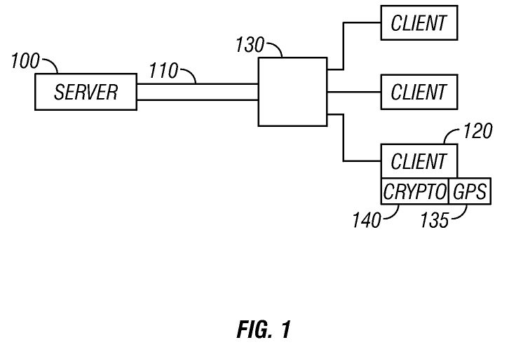

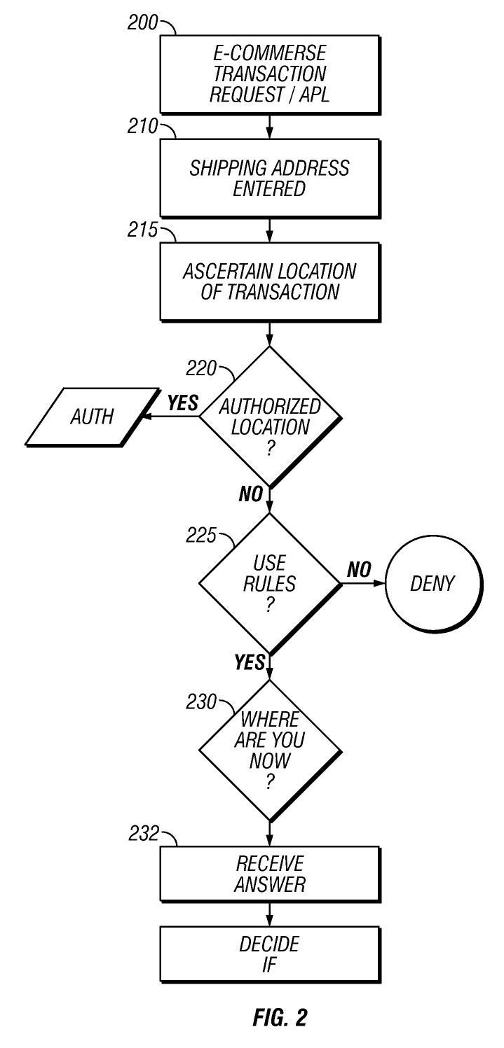

Hardware of a computer system connected to a remote communications medium is shown in FIG. 1. A server computer 100, at a central location, stores a database of information, as well as a user interface program, and a main program which can run a network interfacing program, such as a web browser. The server computer 100 is connected to a network 110, which connects the server 100 to a plurality of client computers. The network can be the Internet, or can be any other network that allows an exchange of information. For example, in one embodiment, the network 110 may be a dedicated dial-up or LAN network. The network comprises at least an information line, and a router 130. The information line 110 can be a telephone line and the router 130 can be the internet backbone, for example. The server computer 100 runs a routine that is described with reference to the flowchart of FIG. 2.

Many client computers can be connected to the server 100. Client 120 is shown at a remote location. The client computer 120 can be any computer which is capable of running a network interfacing program such as a web browser. In addition, the client computer can have various peripherals attached thereto. These peripherals include an automatic location detecting device 135. This can be a satellite positioning system (SPS), such as a GPS device 135.

Other techniques of detecting the location can also be used besides SPS. For example, if done over a telephone line, a caller ID can be detected and correlated to an address using a database. If done over a network, an Internet type address, such as an IP address, can be detected and similarly correlated. In a dynamic IP environment, security can be enhanced by detecting the IP address and the time. An arrangement with the ISP can verify identity of the specified IP address at the specified time.

In operation, each of the client computers 120 can run the specified routine under control of the server. The different specified routines are described herein. Initially, a profile is entered. Each authorized user enters a profile either in person or over the network. If entered over the network, a security key, such as biometric security or cryptographic security may be necessary to obtain access to the profile modification routine. That profile may later be used along with the computer based transaction as described herein.

Each of the client computers is also shown with cryptographic capabilities such as shown as 140. The cryptographic capabilities may be used to produce an encryption signal representing the automatic location detected information. A non-encrypted signal, referred to herein as SPS, is produced that represents the current automatically-detected location. This signal is transmitted as part of at least one transmission from the client computer 120.

FIG. 2 shows an operation to use this system to carry out an e-commerce transaction. At 200, the user, at client 120, begins a transaction. This sends a request for transaction “request”, along with automatic position location information “APL” to the server at 200. Since this is an e-commerce transaction, the server will be sending a product to a specified location. This shipping address is entered at 210. Previous systems have required that this shipping address match to the billing address on the form of payment, e.g., the credit card used for the transaction. This, however, may limit the user's options. The present system instead detects the location of the transaction at 215 from the APL information. Step 220 determines if the location is an authorized location for the specified payment form, e.g., credit card, e-cash, check or the like.

As part of the initial profile associated with the credit card, the user may be required to define authorized locations for use of their credit card. Currently, credit cards are often shipped with a sticker that requires the user to dial a specified number to activate the credit card. Analogously, the present system may require that the user activate their credit card or transaction capability from all locations which they want to consider as being authorized. The user can set a plurality of authorized locations in this or any other way, any of which will be accepted at 220. That is, if the automatic position location information matches a pre-authorized location at 220, then the transaction is authorized. If not, control passes to 225, which determines whether additional rules will be used. This may vary from authorization to authorization. It can also depend on the location that is detected by the APL information. For example, if the location represented by the APL is one which has been used for fraudulent transactions previously, then the transaction may be denied. Similarly, specified public locations, such as pay phones and other public locations may cause the transaction to be denied. Other kinds of verification information, however, may still permit the operation to proceed.

If the location is not authorized, the operation can proceed in one of multiple different ways.

230 shows the system asking the user for their current location. At step 232, the user enters that information and it is sent back to the client. The information is correlated with a database of APL information. If the answer to the “challenge” is verified as being correct, the user may be given an opportunity to either add the current location as a temporary authorized location or as a permanent authorized location. By operating in this way, the location from which the transaction is originated can be used as an additional item of security. This can be used in addition to, or in place of, the currently used systems.

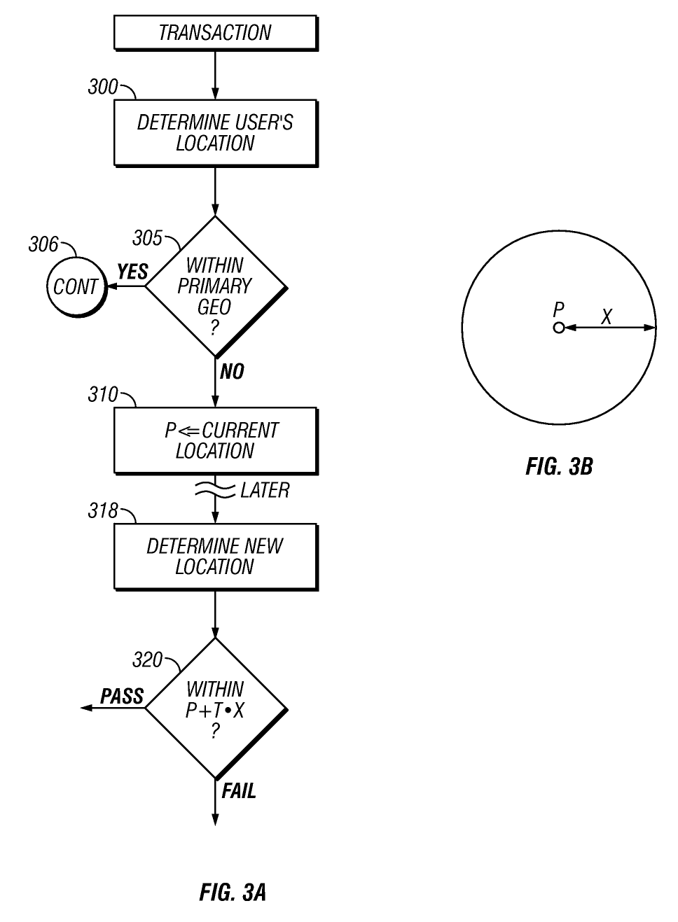

An additional layer of security can be provided as shown in FIG. 3A. When a credit card or cellular telephone is stolen, it is often used multiple times before the theft is detected. This system automatically locates the user using an automatic position location system, such as satellite global positioning system, triangulation, or caller ID. At 305, the system first determines whether the user is within their primary geographic location. For a credit card, for example, this may be within 100 miles of their home address. Similarly, for a portable telephone, this can occur when the user is inside their home network, i.e. not roaming. If within their primary location, no further information will be gathered from the particular test shown in FIG. 3A, so the operation is shown as continuing at 306. However, if the user is not within their primary area, then the variable P is set to the current location at 310. This variable P then sets the allowable limits within which the user is allowed to travel. This is illustrated with reference to FIG. 3B. If the user is at P at a time (t)=0, then that some time t the user cannot have traveled more than x miles. For instance, on an airplane, perhaps a user could travel 500 miles per hour. In any case, the location P sets a geographic limit, which is expanded by time, and within which the user must be located.

At some later time, the user attempts to use their credit device once again. At 318, the system automatically determines the user's new location. At 320, the system determines if that new location is within the allowable circle shown in FIG. 3B. This allowable circle can take into account different variables such as how far the user can travel on any available flight, or, if not on a flight, how far they can have traveled by car. If the user is within the circle, they pass the test.

The x value can be variable, for example, depending on proximity to an airport, and/or airport timetables. For instance, the current APS information indicates that the user is in Detroit, the soonest that a user could get to Dallas might be dictated by plane schedules. This can also be included within the allowable x value.

However, if the user is outside the circle, the test may fail. This prevents a card from being stolen and used to make many transactions in different geographic locations prior to the theft being reported.

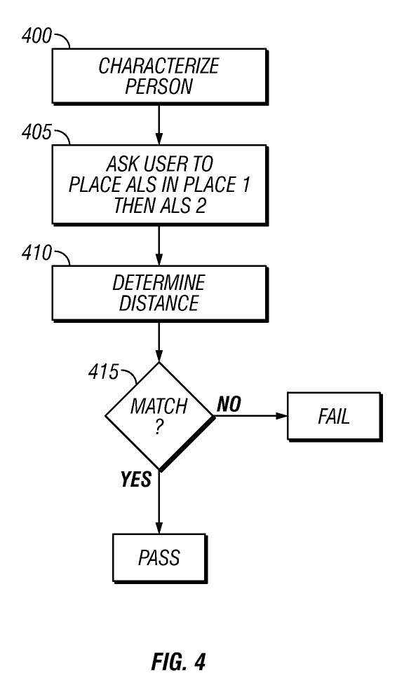

Another embodiment further enhances the transaction by use of biometric information. An automatic position location detection system for biometric verification is shown in FIG. 4. Biometrics have been used to identify a person, e.g. by their fingerprints or by some other identifying information. In each of these systems, however, a weak point includes the ability for an unauthorized user to make a copy of the authorized user's biometric information. A person could conceivably make a copy of a fingerprint, retinal scan or even faceprint to use to fool a biometric system. The present embodiment uses biometrics to identify a person by determining distances between various parts of their body. In this embodiment, an initial setup may require entirely characterizing a person's body shape and lengths of different parts. This is shown at 400. This can be done by an automated system, e.g. one which uses microwaves to determine positions and sizes of the various body parts. After the person's body is characterized, the system may require biometric verification in the form of a challenge.

The system asks at 405 the user to first place the automatic location system (ALS) in place one and then in place 2. For example, this may ask first the user to place the ALS on their toes and then on their knees. 410 determines a distance between the two locations. At 415, the server obtains this distance and determines, from the prestored profile, if the distance is correct. If so, the item passes. This can be especially useful in a portable computer, such as a PDA or cellular telephone.

Another verification system includes verification of handwriting. Credit card transactions are often verified by a signature. The signature can include writing with a pen on paper, or in certain automated systems by writing with a special stylus on a special tablet. The present system, however, uses a special stylus which includes an automatic location system such as SPS in its tip which detects the movement of the device.

The writing instrument as shown includes a SPS device 500 in tip 501 of the stylus. The SPS device 500 is powered by a battery 510. Information from the SPS device is stored in a memory 516. The SPS device is also equipped with an information transmitter 515. This is shown as being Bluetooth, but could be any other system which is capable of sending information over a channel. The stylus 500 also includes electrical contacts 522 which mate with corresponding contacts on the PDA 520. This can be done to recharge the battery 510 and also can allow information to be exchanged between the memory 516 and the PDA 520.

Hence, this system can operate in one of two different modes, either wirelessly sending information in semi real time from the Bluetooth transceiver 515 to the PDA, or in an offline mode in which the information is stored in the memory 516 and dumped once docked. In either case, the motion of the tip 501 of the stylus 500 is transferred to the computer 520.

This motion represents the movement of the tip of the writing in time and space. By detecting this position, the system can track various things about the stylus tip. The system can track whether the tip is up or down. The downmost position of the tip can be assumed to be on the paper or writing pad against which the stylus 500 is pressed. When the stylus is above this by more than a centimeter or so, the tip can be assumed to be up, that is raised from the paper. This therefore can be used to track the line of the signature i.e. the line that would be formed on the paper by a signature. The line that would be formed on this paper can be used to track the static characteristics of the signature and those static characteristics of the signature can be compared with a pre-stored value indicative of an authorized signature.

Since the information about the signature is monitored as the signature is obtained, the dynamic aspects can also be obtained. A well trained forger may be able to learn to produce a reasonably decent facsimile of a signature. However, by tracking dynamic aspects, that is how fast the user makes various parts of the signature stroke, an additional layer of security is obtained. A forger not only needs to learn how to sign the signature so that signature looks right, but also how to sign the signature in the same way as the authorized user signs it. The forger obtains no information on how to do this from a simple view of the signature itself. By monitoring static and dynamic characteristics, the security can therefore be enhanced.

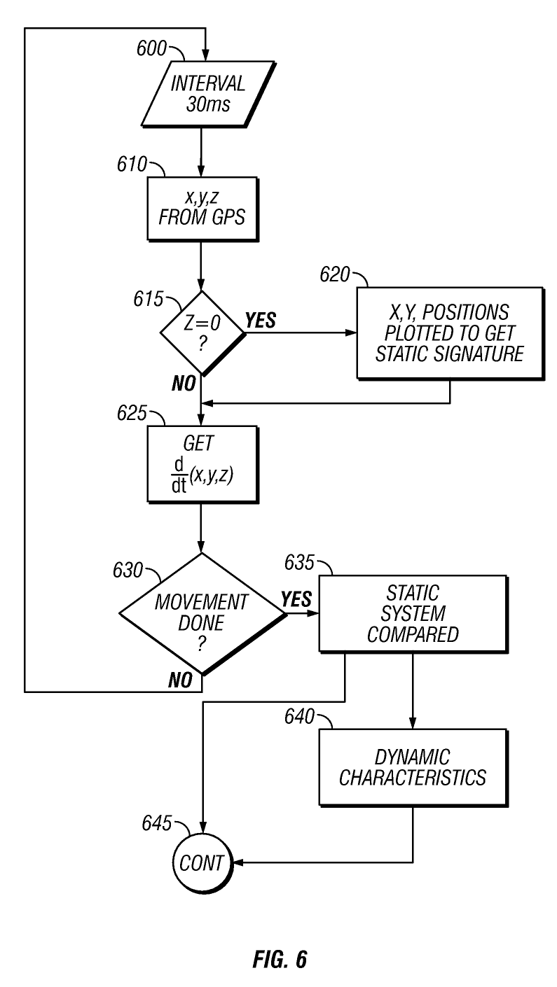

The present system may monitor both static and dynamic parameters. The operation proceeds as shown in FIG. 6. At each interval of time, e.g. each 30 ms, the x, y and z positions from the GPS device are obtained at 610. 615 determines if z=0, where 0 is the downmost position of the GPS device. If so, the x and y positions are plotted to obtain the static signature portion at 620. Each 30 ms, for example, an additional x and y position may be obtained. At 625, whether the pen is up or down, an instantaneous differential of the x, y and z movement is obtained. 630 determines if the movement is over, that is if the signature is complete. If not, flow returns to 600 where the next sample is determined after another 30 ms. If movement is completed at 630, the static signatures are compared at 635. This can be done using any available signature detection technique, for example those using hidden Markov models and other techniques. At 640, the dynamic characteristics are compared with dynamic characteristics of a pre-stored sample. Scoring is carried out in a conventional way to determine a pass or fail at 645.

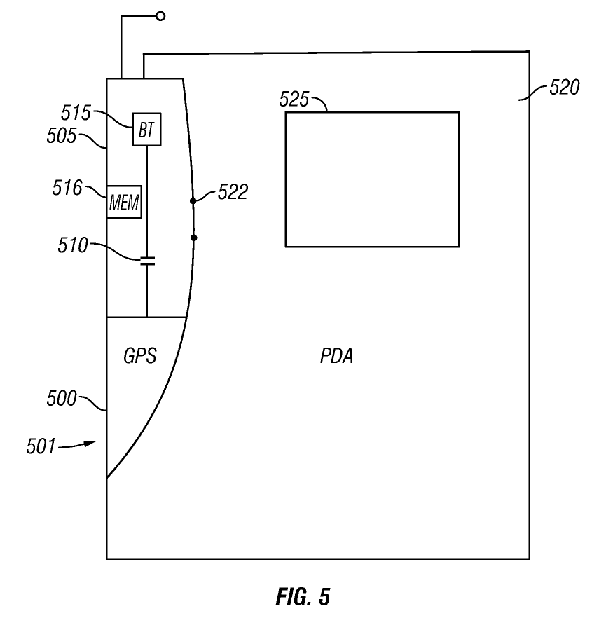

The embodiment of FIGS. 5 and 6 have disclosed using this technique for signature verification, that is to determine if a user's signature is authorized. However, this technique is also contemplated for use in handwriting recognition. Many different software techniques of handwriting recognition are known. The x, y and z information obtained in the flowchart of FIG. 6 can also be used for this handwriting recognition.

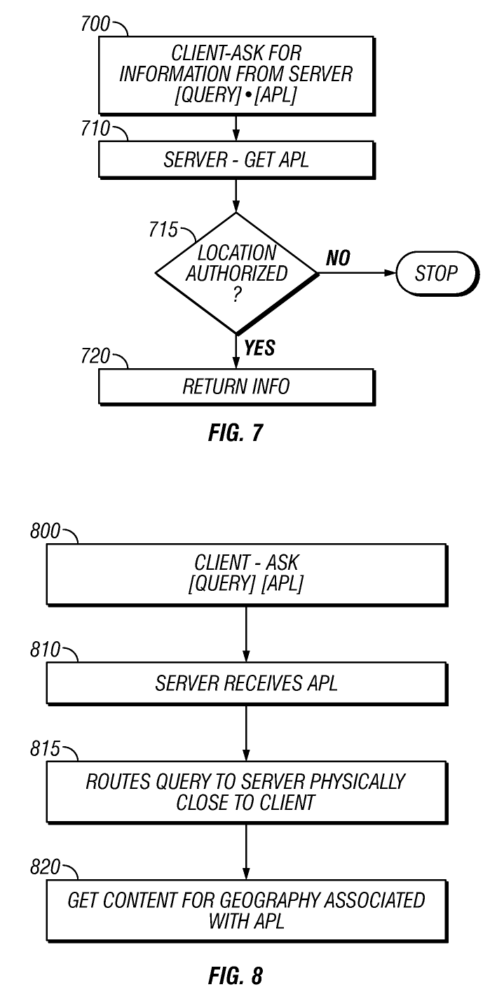

FIG. 7 shows a transaction used for determining information to be obtained from a website. This embodiment may be especially useful with a portable computer such as a laptop computer, PDA or cellular telephone. In these kinds of computers, the location of the computer may be moved. However, this is also useful in a desktop computer. In this embodiment, shown in FIG. 7, a client asks for information from a specified server at 700. This is in the form shown in 700, where the query is made. The query is also associated with automatic position location information indicative of the location of the client.

The server gets the APL information at 715, and compares it with its database of authorized information. At 715 the server determines if the location is authorized. If not, no information is returned. If so, information is returned at 720.

This embodiment enables a locational restriction on delivered content. An owner or manager of a premise may request that the content of certain websites be entirely restricted from being delivered to their premises. For example, a workplace may restrict all Internet traffic or may restrict adult sites only. The restriction may be total, or may only be in force at certain times, e.g. during working hours.

The website server gets the APL information at 710. The APL is used to determine if information should be returned from the website's server at 715.

The detection can be done in one of two ways. A restriction request may be sent to the server, defining GPS coordinates that are restricted. Later, if those GPS coordinates match with the restricted coordinate system, then no information is returned from the website. The converse is also possible, that the website will only return information from GPS coordinates which are approved. The embodiment of FIG. 7 shows allowing information to be returned from a website at 720 if authorized. The opposite is possible.

This same technique can also be used to provide other services. One such service is license of a product such as a software product or the like. Users often purchase site licenses for their software. This may allow all computers on a specified site to run the software. In this embodiment, each time a computer is activated, it can run the routine of FIG. 7. The client includes software which prohibits its operation unless a positive response from a remote server. At 700, the client sends a request to this remote server with the query for authorization along with APL. The server gets the APL at 710, determines if the site coordinates are authorized, and if so returns the verification at 715. If the site coordinates are not authorized, the server does not return a verification or conversely returns a denial. This can prevent the software from running at other than the authorized location. The site coordinates here may include a specified size which may include the size of the building.

An alternative operation shown in FIG. 8 allows multiple versions of information to be returned depending on the location of a request. Some websites may be available in multiple languages. For example, when one calls on a website, one is frequently queried what language the website should use. The initial query to the website may be to a site which may very far from the user. Only after the proper selection is the user properly routed to the closest possible website. This can add to Internet traffic and also can be annoying to the user.

In the modification shown in FIG. 8, the client again asks for information from the server, again in the form [query] [APL] where APL can be any kind of automatic position location information such as SPS or others at 800. The server receives the APL at 810. At 815 the server routes the query to a determined server. This can be a server which is physically close to the client as determined from the APL information or may be based on other characteristics, for example website traffic. Some websites may service all locations of the world from a single location server, in which case 815 may not be carried out.

At 820 the server gets content for the geography associated with the APL. This content can be in the language for the APL's home country. For example, if the APL coordinates indicate that the query is coming from the United States, then U.S. English could be returned. British or Australian versions of the English could be returned for other such APL coordinates. Japanese, Chinese or any other language can be returned if the coordinates indicate that location.

Licenses to goods may also be handled by this system. For example, some goods may be licensed for sale only in certain geographic locations. Certain products may be sellable in one geographic location, but not in others. Certain products may have different prices when sold in different geographic locations. So called gray market goods may include a true authorized product which is not authorized for sale in a specified geographic location. For example, different versions of video equipment, video games, and like are provided for each different geographic location. A website operator may not want to, and in fact may not be allowed to, display content associated with the wrong geographic location. For example, a user in the United States might not be allowed to view the products which can be purchased by a person in Singapore.

This system also enables tailoring the content of the website as well as the website's language, based on the automatic position location. Since the position of the user is automatically determined, the contents of the website are automatically returned based on the user's position. This facilitates truly multi-national websites, with each page of content being based on the user's automatically detected location.

Yet another embodiment uses this system to verify users in a chat room. In the past, stalking and other actions have occurred via Internet chat rooms. The Internet chat rooms have a problem that the users may be often anonymous. The present system in this embodiment enables more information to be determined to provide an ID for those users.

The system when used in a chat room environment provides an ID for a user. The user can enter a specified profile shown as step 900. In that profile, the user can enter certain information about themselves, e.g. their name and age and the like. APL is also detected at 910. Once an authorized profile is entered, the user may be assigned a user ID and password, and hence allowed access to the chat room. This can facilitate determining more information about the person in the chat room should it be necessary later on.

If the user desires to enter the chat room, the user is not allowed to do so unless the user has a profile in one embodiment. In another embodiment, the user is allowed to enter the chat room with different rights depending on the profile they enter. The system can use APL to automatically detect the location of each user each time they enter the Chat Room.

Since the system determines the location of the person, anonymity can be granted, but a trail to any such person may still exist.

Moreover, the APL can serve as an identifier. A person, and that person's APL, may be denied further access to a chat room, for example, based on previous bad behavior.

Although only a few embodiments have been disclosed in detail above, other modifications are contemplated.

What is claimed is:

1. A method comprising:
automatically determining a position of a computer and producing an automatic position location signal indicative thereof;
sending said automatic position location signal over a remote communication medium, along with operation information indicative of an operation to be conducted; and
receiving said signal indicative of automatic position location and said information in a server of the remote communication medium, comparing said signal indicative of automatic position location to information in a database of said server, and using said automatic position location signal to automatically determine a language for the information to be returned from said website.

2. A method as in claim 1 wherein said sending comprises encrypting said automatic position location signal, prior to said sending.

3. A method as in claim 1 wherein said automatic position location signal is a signal from a satellite positioning system.

4. A method comprising:
automatically determining a position of a computer and producing an automatic position location signal indicative thereof;
sending said automatic position location signal over a remote communication medium, along with operation information indicative of an operation to be conducted;
receiving said signal indicative of automatic position location and said information in a server of the remote communication medium which stores information about a plurality of different products and stores geographical information associated with said products; and using said automatic position location signal to automatically determine which of a plurality of products will be displayed based on a geographic region determined from said automatic position location signal, and returning information of only certain products for said geographic region that is automatically determined from said automatic position location information signal.

5. A method as in claim 4 wherein said information comprises information indicating whether a particular location is authorized to receive information from a particular website.

6. A method, comprising:
automatically determining a location of a request for information from a server; and
returning information from said server that is based on said location, and is automatically different for one location than for another location.

7. A method as in claim 6 wherein said automatic position location information includes satellite positioning information.

8. A method as in claim 7 wherein said returning comprises failing to return certain information to specified locations.

9. A method as in claim 6 wherein said returning comprises determining a type of information which should be returned to specified geographic locations based on said location.

10. A method as in claim 9 wherein said type of information is a language of the information.

11. A method as in claim 9 wherein said type of information is products which are allowed in specified geographic locations.

12. A method as in claim 6 wherein said returning comprises an indication of whether entry to a chat room is allowed.

13. An apparatus comprising:
a computer, and
a position location element, associated with said computer, said position location element automatically producing a position information signal that indicates a position of said computer; and
said computer including a memory storing information, and running a specified routine based on a request, which compares said position with said information, and returns information from a website based on both on said signal, and said request.

14. An apparatus as in claim 13, wherein said computer returns a language of said website based on said position.

15. An apparatus as in claim 13, wherein said computer returns a subset of available products, based on said position, where some products are allowed in some positions, and not in other positions.

16. An apparatus as in claim 13 wherein said position detecting element is a satellite positioning system detecting element.

17. An apparatus as in claim 13 further comprising an encrypting layer, encrypting at least said position information.
